(19) United States
(12) Patent Application Publication
(10) Pub. No.: US 2018/0305242 A1
(43) Pub. Date: Oct. 25, 2018

(54) LOW-MELTING-POINT COMPOSITION, SEALING MATERIAL, AND ELECTRONIC COMPONENT

(71) Applicant: Nihon Yamamura Glass Co., Ltd., Hyogo (JP)

(72) Inventor: Takuro IKEDA, Hyogo (JP)

(21) Appl. No.: 15/770,089

(22) PCT Filed: Aug. 31, 2016
(86) PCT No.: PCT/JP2016/075411

§ 371 Date: Jun. 18, 2018

(30) Foreign Application Priority Data
Oct. 22, 2015 (JP) 2015-208054

(51) Int. Cl. C03C 8/06; C03C 3/23

(52) U.S. Cl. CPC C03C 8/06; C03C 2205/00; C03C 3/23

(57) ABSTRACT

Disclosed as a lead-free, inorganic low melting-point composition which, when applied to an object to be sealed having surfaces made of inorganic oxide and/or metal, and then subjected to heat treatment in the air in a temperature range not exceeding 400° C., sufficiently expands over the surfaces exhibiting good wettability to it, and thus is able to adhere (stick fast) to the surfaces and seal them once cooling down and making solid, and also to join two of their surfaces which are laid on each other.

### TECHNICAL FIELD

The present invention relates to an inorganic composition, more specifically to an inorganic low melting-point composition, a low melting-point sealant, and electronic components produced using the same.

### BACKGROUND ART

A variety of inorganic low melting-point compositions are used in different applications in the electric and electronic devices industry. For example, an Au—Sn alloy solder paste or a sealing glass frit having a low melting-point (e.g., 250° C.) is used to provide a seal for electric/electronic components, such as quartz resonators and LED chips, in the manner in which it is applied to them and subjected to firing.

Although Au—Sn alloy (Patent document 1) is a reliable material which has long been employed, it is a very expensive material because of gold contained in it.

Thus, PbO-based glass and V₂O₅-based glass have also been known as less expensive low melting-point glass that can be employed in preparing sealants. For example, a PbO-based glass that can be used for sealing at temperatures lower than 400° C. (Patent document 2), and a V₂O₅-based glass that can be fired at or below 350° C. (Patent document 3).

In addition, a sealing material that can be used at 300-330° C. is known which contains silver oxide and/or silver halogenate along with other metal oxides (which may be Pb and V) (Patent document 4).

Further, there is also known a sealing material containing silver oxide, phosphorous peroxide, and silver iodide (Patent documents 5 and 6).

In this situation, a more reliable and less expensive sealant has come to be needed in parallel to the advancing miniaturization in recent years of circuit structures of electric/electronic devices. Such a request, however, has not yet been adequately met.

### PRIOR ART DOCUMENTS

### Patent Documents

[Patent Document 1] Japanese patent application publication No. H09-122969
[Patent Document 2] Japanese patent application publication No. S61-261233
[Patent Document 3] Japanese patent application publication No. 2013-32255
[Patent Document 4] Japanese patent application publication No. H05-147974
[Patent Document 5] Japanese patent application publication No. 2000-183560
[Patent Document 6] Japanese patent application publication No. 2001-328837

### SUMMARY OF INVENTION

### Technical Problem

An objective of the present invention is to provide a lead-free, inorganic low melting-point composition which, when applied to an object to be sealed having surfaces made of an inorganic oxide and/or metal, and then subjected to heat treatment in the air in a low temperature range not exceeding 400° C., preferably not exceeding 350° C., sufficiently expands over the surfaces exhibiting good wettability to it, and thus is able to seal them once cooled down by making solid and adhering (sticking fast) to the surfaces, and also able to join two of such surfaces that are laid on each other. Another objective of the present invention is to provide a low melting-point sealant comprising the composition. Still another objective of the present invention is to provide electronic devices sealed or joined with the sealant.

### Solution to Problem

In a study of wettability of low melting-point compositions consisting only of Ag, Mo, I and O as the components, to inorganic oxide surfaces, the present inventor discovered that compositions having dark colors, like dark-brown or black, exhibited good wettability, while poor wettability was shown with light-yellow compositions. The present invention was completed through further studies about the relation between the color and the wettability, as well as the relation among the color, the wettability and the composition, where one or more other elements were added to the above composition. Thus, the present invention provide what follows.

1. A low melting-point composition comprising one or two elements chosen from Mo and W, and further Ag, I, and O as essential components, wherein the composition, as expressed as a mass of different compounds each formed of a cation-anion combination represented by the formula MQ_{m/q}, wherein M denotes a cation having a valence of m, and Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

(2×MoO₃+2×WO₃+3×PO_{5/2})/(AgO_{1/2}+R¹O_{1/2}+2×R²O)<1, wherein R¹ denotes an alkali metal, and R² denotes alkaline earth metal, and

wherein the composition exhibits a small contact angle with an oxide surface.

2. A low melting-point composition comprising one or two elements chosen from Mo and W, and further Ag, I, and O as essential components,

wherein the composition, as expressed as a mass of different compounds each formed of a cation-anion combination represented by the formula MQ_{m/q}m, wherein M denotes a cation having a valence of m, and Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

wherein the absorption edge wavelength λg of the composition is 480 nm or longer.

3. The low melting-point composition according to 1 or 2 above comprising one or two elements chosen from Mo and W, and further Ag, I, and O, as exclusive components, and

the composition satisfies (2×MoO₃+2×WO₃)/AgO_{1/2}<1.

4. The low melting-point composition according to one of 1-3 above, containing substantially no AgF, AgCl, nor AgBr.

5. A method for production of a low melting-point composition that comprises one or two elements chosen from Mo and W, and further Ag, I, and O, and exhibits a small contact angle with an oxide surface, comprising the steps of:

providing and blending raw materials so that the composition, as expressed as a mass of different compounds each formed of a cation-anion combination represented by the formula MQ_{m/q}, wherein M denotes a cation having a valence of m, Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

(2×MoO₃+2×WO₃+3×PO_{5/2})/(AgO_{1/2}+R¹O_{1/2}+2×R²O)<1, wherein R¹ denotes an alkali metal, and R² denotes alkaline earth metal, and
heating to turn the raw materials into a melt, and
cooling the melt into a solid.

6. A method for production of a low melting-point composition that comprises one or two elements chosen from Mo and W, and further Ag, I, and O, and exhibits a small contact angle with an oxide surface, comprising the steps of:

providing and blending raw materials so that the composition, as expressed as a mass of different compounds each formed of a cation-anion combination represented by the formula MQ_{m/q}, wherein M denotes a cation having a valence of m, Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

the absorption edge wavelength λg of the composition is 480 nm or longer, and
heating to turn the raw materials into a melt, and
cooling the melt into a solid.

7. The method for production according to 5 or 6 above, comprising the steps of:

providing and blending raw materials so that the low melting-point composition comprises one or two elements chosen from Mo and W, and further Ag, I, and O, as exclusive components, and further

(2×MoO₃+2×WO₃)/AgO_{1/2}<1, and

heating to turn the raw materials into a melt, and

cooling the melt into a solid.

8. The method for production according to one of 5-7 above, comprising the steps of providing and blending raw materials so that the low melting-point composition contains substantially no AgF, AgCl, nor AgBr, heating to turn the raw materials into a melt, and cooling the melt into a solid.

9. A low melting-point sealant comprising the low melting-point composition according to one of 1-4 above.

10. An electronic component produced using the sealant according to 9 above.

11. An electronic component comprising two or more members joined with the low melting-point sealant according to 9 above.

12. The electronic component according to 10 or 11 above as a quartz resonator, a semiconductor element, an SAW element, or an organic EL element.

### Effects of Invention

The inorganic low melting-point composition according to the present invention can be applied in the form of a low melting-point sealant containing it, to the surfaces made of inorganic oxide and/or metal of an object to be sealed, and then heated in a broad temperature range not exceeding 400° C. in the air to melt and expand as desired, and once cooled to solidify, it provides the surfaces with a seal sticking sufficiently fast to them. Further, in the state of a melt, it shows a particularly high wettability to inorganic oxides. It therefore is suitable especially for use in sealing an object having inorganic oxide surfaces.

### BRIEF DESCRIPTION OF DRAWINGS

FIG. 1 is a schematic diagram of the structure of a quartz resonator shown in a disassembled state in which the sealant is employed.

FIG. 2 shows the spectral transmittance curves as internal transmittance of low melting-point Compositions 3 and 5, at a thickness of 50 μm.

FIG. 3 is a schematic diagram showing the contact angle θ with a drop of liquid and the parameter used for calculating θ.

### DESCRIPTION OF EMBODIMENTS

In the present invention, the term “low melting-point” means that the melting point does not exceed 400° C., more preferably not exceeding 350° C. The low melting-point glass composition according to the present invention can be used to purposes compatible to its melting point. A composition having the melting point in the range of 250-350° C., for example, can be used as an inexpensive alternative material to an Au—Sn alloy sealant. Further, a composition having the melting point not exceeding 250° C. can also be used to provide an additional seal for electronic components in which an Au—Sn alloy solder is already employed.

In defining the present invention with its components and their quantitative relations, it is regarded, for convenience's sake, that the composition is a mass of different compounds each formed of a combination of a cation and an anion originating from the raw materials, which is represented by the formula MQ_{m/q}, wherein M denotes a cation having a valence of m, Q denotes an anion having a valence of q, and that any anion except the oxide anion (O²⁻) is bound to Ag ion. Besides, under the aforementioned quantitative condition that the composition satisfy, an inequation holds: [molar number of Ag ions]<[sum of molar numbers of each anion except oxide×its valence].

The low melting-point composition according to the present invention exhibits sufficient wettability to inorganic oxides at a temperature not exceeding 400° C., preferably in the range of 200-400° C., for example, and more preferably 250-350° C. Therefore, the composition may be applied in the form of particles (e.g., powder or paste) to an object to be sealed having surfaces made of inorganic oxide or metal, then heated to the above mentioned temperatures to flow and expand over the surfaces of the object to be sealed, and after cooled to solidify, it provides a seal by sticking to the surface of the object to be sealed.

In the composition of the present invention, AgI is an essential component, which is effective in lowering the liquidus temperature as well as in promoting formation of glass phase. To make use of these effects, the content of AgI is preferably 12-82 mole %, more preferably 20-76 mole %, and still more preferably 23-73 mole %.

AgO_{1/2} is also an essential component of the composition of the present invention. AgO_{1/2} is effective in supplying oxide ion (O²⁻) to cations M^{m+} other than Ag+(mainly Mo⁶⁺), causing changes in the coordination number of M^{m+} and the number of bonds in MOₙ^{(2n-m)-} coordination polyhedron, and thereby in forming a liquid phase and a glass phase of the composition, as well as in enhancing adhesiveness to oxides. To utilize these effects, the content of AgO_{1/2} is preferably 12-60 mole %, more preferably 16-54 mole %, and still more preferably 18-52 mole %.

At least one of MoO₃ or WO₃ is also an essential component of the present composition, and they are effective in lowering the liquidus temperature of the composition, in promoting formation of glass phase, and in increasing adhesiveness to inorganic oxides. To utilize there effects, the total content of MoO₃ and WO₃ is preferably 6-28 mole %, more preferably 8-26 mole %, and still more preferably 9-25 mole %.

MoO₃ is effective in relatively lowering the melting point, while WO₃ is effective in relatively raising the melting point. To obtain a composition which flows at 300° C. or lower, the molar ratio MoO₃/(MoO₃+WO₃) is preferably 0.2-1.0, and more preferably 0.5-1.0. To obtain a composition which shows heat resistance that prevents it from softening at 250-300° C. yet allows it to flows at 300-400° C., the molar ratio MoO₃/(MoO₃+WO₃) is preferably 0-0.2, and more preferably 0-0.05.

For the composition of the present invention to melt at a temperature not exceeding 400° C., the total content of silver compounds represented by AgQ_{1/q} (ΣAgQ_{1/q}) is preferably 68-94 mole %, more preferably 70-92 mole %, and still more preferably 72-91 mole %.

For the composition of the present invention to melt at a temperature not exceeding 400° C., the total content of oxide components represented by MO_{m/2} (ΣMO_{m/2}) is 18-84 mole %, more preferably 24-80 mole %, and still more preferably 27-77 mole %.

Regarding the composition according to the present invention, the inventor found that a strong correlation exists between the color of the composition and its wettability to oxides.

For the composition of the present composition to exhibit sufficient wettability to oxides, it is necessary that the composition has a dark color such as brown, and more specifically, the absorption edge wavelength λg of the composition is 480 nm or longer. More preferably, Ag is 484 nm or longer.

Regarding the composition of the present invention, the term “absorption edge wavelength Δg” means the wavelength at which 50% internal transmittance is observed with the composition when its thickness is 50 μm. To prepare the composition into 50 μm-thick film with a uniform thickness as a sample for transmittance measurement, it is sufficient to put the composition heated beyond its melting point between two glass microscopic slides, press it to expand, and let it cool down. By placing spacers (glass beads, or the like) between the glass microscopic slides, uniformity of the film's thickness could be guaranteed. Although determination of internal transmittance generally requires to remove the influence of reflection of the light by the air-glass microscopic slide interface as well as by the interface between the glass microscopic slide and the low melting-point composition, it can be substituted by the total transmittance at 700 nm [T(700 nm, t)] because the composition of the present invention shows little absorbance at 700 nm. Furthermore, the internal transmittance of visible light is almost 100% with glass microscopic slide. Based on these, the internal transmittance τ (λ, t), at wavelength λ and thickness t, can be determined by Numerical Formula 1. Thus, the internal transmittance where the sample thickness is 50μ, τ (λ, 50 μm), can be determined by Numerical Formula 2. The wavelength at which the value of τ (λ, 50 μm) thus determined comes equal to 0.5 is designated λg (Numerical Formula 3).

$$\begin{matrix}τ ( λ , t ) = \frac{T ( λ , t )}{T ( 700 nm , t )} & [ Numerical Formula 1 ] \\ τ ( λ , 50 µm ) = {\{ τ ( λ , t ) \}}^{( \frac{50 µm}{t} )} & [ Numerical Formula 2 ] \\ τ ( {λ}_{g} , 50 µm ) = 0.5 & [ Numerical Formula 3 ]\end{matrix}$$

The present inventor found that in the case of a composition consisting only of Ag, Mo, I, and O, if it is adjusted to satisfy a relational expression, 2×MoO₃/AgO_{1/2}<1, it acquires the aforementioned color, and exhibits sufficient wettability to oxides, too, in such a situation.

In a composition consisting only of Ag, Mo, I, and O, the ions are said to exist in the forms of Ag⁺, I⁻, and Mo₂O₇²⁻, which is a condensate of MoO₄²⁻. In the case where the above relational expression holds, an excessive amount of O²⁻ ion exists even after MoO₄²⁻ is formed, and thus it is thought that this brings about lattice defects, thereby changes the color of the composition to brown. Further, it is also considered that the “excessive O²⁻ ion” influences on the adhesiveness to the oxide surface of the material to which adhesion is intended, so that an sufficient wettability is achieved.

Likewise, the present inventor found that in the case of a composition consisting only of Ag, W, I, and O, if it is adjusted so as to satisfy a relational expression, 2×WO₃/AgO_{1/2}<1, it acquires the aforementioned color, and shows sufficient wettability to oxides, too, in such a situation.

It was found by the present inventor that in the case of a composition containing both Mo and W, if it is adjusted to satisfy (2×MoO₃+2×WO₃)/AgO_{1/2}<1, it acquires the above color, and shows sufficient wettability to oxides, too.

The present inventor also found that in the case where PO_{5/2} is further added to a composition consisting of Mo and/or W, and Ag, I, and O, the added PO_{5/2} turns into such forms as PO₄³⁻ and consumes O²⁻ ion, which thus increases the need for AgO_{1/2} compared with a composition containing no PO_{5/2}. In this case, if the resulting composition is adjusted to satisfy (2×MoO₃+2×WO₃+3×PO_{5/2})/AgO_{1/2}<1, the above color is acquired, as well as a sufficient wettability to oxides.

In the case where alkali metal oxide R¹O_{1/2} is further added to a composition consisting of Mo and/or W, and Ag, I, and O, as the added R¹O_{1/2} turns into the form of R⁺ and releases O²⁻ ion, it is allowed to reduce the content of AgO_{1/2} compared with a composition containing no R¹O_{1/2}. It was found by the present inventor that in such a case, if the composition is adjusted to satisfy (2×MoO₃+2×WO₃)/(AgO_{1/2}+R¹O_{1/2})<1, the above color is acquired, as well as a sufficient wettability to oxides.

In the case where alkaline earth metal oxide R²O is further added to a composition consisting of Mo and/or W, and Ag, I, and O, as the added R²O turns into the form of R²⁺ and release O²⁻ ion, it is allowed to reduce the content of AgO_{1/2} compared with a composition containing no R²O. It was found by the present inventor that in this case, if the composition is adjusted to satisfy (2×MoO₃+2× WO₃)/(AgO_{1/2}+2×R²O)<1, the above color is acquired, as well as a sufficient wettability to oxides.

For sufficient wettability in the case where optional components, P, R¹, and R², are added to a composition consisting of Mo and/or W, and Ag, I, and O, the value of (2×MoO₃+2×WO₃+3×PO_{5/2})/(AgO_{1/2}+R¹O_{1/2}+2×R²O) is preferably adjusted to be not more than 0.99, more preferably not more than 0.98, and still more preferably not more than 0.95.

As shown above, a clear tendency is noted. Namely, if the extra component added is an acidic oxide, the necessary amount of AgO_{1/2} increases; if it is a basic oxide, the necessary amount of AgO_{1/2} decreases; and if the extra component added is an ampholytic oxide, there occurs no significant change in the necessary amount of AgO_{1/2}.

The above indicate that if a it is adjusted to satisfy the aforementioned relational expressions, the composition consequently contains AgO_{1/2} at least a certain level, which leads to a sufficient wettability to inorganic oxide surfaces, and at the same time, the composition exhibits the aforementioned color due to the AgO_{1/2} contained at such a level. Therefore, where a composition exhibits the aforementioned color, it indicates that the composition contains AgO_{1/2} at least a certain level as mentioned above, and thus possesses a sufficient wettability to inorganic oxide surfaces.

In adjusting a composition, the wavelength λg, at which the internal transmittance is calculated to be 50% when the composition is 50 μm thick, is determined, and if the Ag thus found is shorter than 480 nm, the composition is modified to contain an increased level of AgO_{1/2}. By repeating this process until the Ag reaches 480 nm or longer, a composition possessing a sufficient wettability can be obtained. Such adjustment and decision can be readily made by a person skilled in the art in the light of the description of the present specification.

The composition of the present invention may contain other silver halides than AgI (AgF, AgCl, AgBr) as optional components. These optional silver halide components can be employed for adjusting solidus temperature, liquidus temperature, thermal expansion coefficient, modulus of elasticity, and the like. The total content of these optional silver halides is preferably not more than 5 mole %, more preferably not more than 3 mole %, and still more preferably not more than 0.1 mole %. Besides, in the present invention, a statement that the composition “contains substantially no AgF, AgCl, nor AgBr” means that the total content of AgF, AgCl, and AgBr is not more than 0.01 mole %.

The composition of the present invention may contain AgS_{1/2} as an optional silver compound component. AgS_{1/2} can be used in adjusting solidus temperature, liquidus temperature, thermal expansion coefficient, and modulus of elasticity, as well as to improve electrochemical stability. The content of AgS_{1/2} is preferably not more then 20 mole %, more preferably not more than 10 mole %, and still more preferably no more than 5 mole %.

The composition of the present invention may contain ZnO as an optional oxide component. ZnO is effective in increasing the adhesion strength to oxides, i.e., a material to be sealed. The content of ZnO is preferably 0.1-10 mole %, more preferably 0.7-8 mole %, and still more preferably 1.5-5 mole %.

As optional oxide components, the composition of the present invention may contain LiO_{1/2}, NaO_{1/2}, KO_{1/2}, RbO_{1/2}, CsO_{1/2}, MgO, CaO, SrO, BaO, ScO_{3/2}, YO_{3/2}, of lanthanoid oxides, TiO₂, ZrO₂, HfO₂, VO_{5/2}, NbO_{5/2}, TaO_{5/2}, WO₃, MnO₂, FeO_{3/2}, CoO_{3/2}, NiO, CuO_{1/2}, BO_{3/2}, AlO_{3/2}, GaO_{3/2}, InO_{3/2}, SiO₂, GeO₂, SnO₂, PO_{5/2}, SbO_{3/2}, BiO_{3/2}, and TeO₂. These optional oxide components can be contained for adjusting solidus temperature, liquidus temperature, thermal expansion coefficient, and modulus of elasticity, and the like. The total content of these optional oxide components is preferably not more than 10 mole %, more preferably not more than 8 mole %, and still more preferably not more than 5 mole %.

The composition of the present invention is lead-free, namely contains no substantial Pb. In the specification, the term “lead-free” means that even in the case where a trace amount of it is contained as a contaminant, the Pb content is less than 1000 ppm. The Pb content is more preferably less than 100 ppm.

The composition of the present invention may also be provided in the form of a mixture of the powders of raw material agents preblended so as to give a low melting-point composition after heated to melt. It may also be provided in the form of a material in which solid solutions, double halides, and glass phases are formed, that is obtainable by heating the above mixture to melt and then cooling it. As formation of solid solutions, double halides, and glass phases makes a composition easier to melt by a short-time heating, a composition of such a form is more preferred. Further, the composition of the present invention can also be produced by causing a reaction in a solution containing acids, bases, or salts and then inducing precipitation.

Further, the composition of the present invention may also be used as a sealant processed in advance into the form of a powder, beads, a rod, or the like. In order for improving efficiency at work, it may be used as a paste-type sealant produced by mixing it with water, an organic solvent, dispersant, thickener, or the like. Terpineol, cellosolve, isobornyl cyclohexanol, and the like may be used as an organic solvent.

Moreover, aiming to improve its sealing performance, the sealant of the present invention may be prepared in such a form that contains one or more fillers having a small thermal expansion coefficient (for example, β-eucryptite, β-spodumene, quartz glass, mullite, cordierite, aluminum titanate, zirconium tungstate, invar alloys) and organic polymer materials having small modulus of elasticity and heat resistance (for example, polyimides, silicone, polytetrafluoroethylene, polyphenylene sulfide, fluoro-rubber, and the like). Furthermore, to give it additional properties, it may be prepared, for example, in a form that contains one or more fillers having high electrical conductivity, such as metal (e.g., metal silver), carbon nanotube, and the like), for giving it electrical conductivity; and in a form that contains one or more fillers having high thermal conductivity (e.g., aluminum nitride, silicon carbide, and the like) for giving it high thermal conductivity. Any of these fillers may be included in the composition of the present invention as part of the components of the sealant of the present invention, in accordance with required performance depending on the way of use and the environment in which the object sealed with the sealant of the present invention is used. The upper limit to filler's content in the sealant so as to retain the flowability of the sealant is about 50 volume %, though it depends on the particle size distribution of the filler.

In using the sealant of the present invention, an object to be sealed may have its surfaces consisting of one or more of various metals, non-metals (inorganic oxides, fluorides, nitrides, carbides, organic polymeric materials, etc.). However, as it has a property to wet oxides, the composition of the present invention is used particularly preferably where at least part of the object to be sealed is made of an inorganic oxide.

Depending on the sealing temperature, the composition of the present invention can be used by choosing a type having a proper contact angle with a glass plate as follows.

In the case of 250° C.: not more than 50°, in the case of 300° C.: not more than 25°, in the case of 350° C.: not more than 15°. Besides, regarding the composition of the present invention, the term “small contact angle” means that the contact angle observed with the surface of a glass plate, inorganic oxides, is not more than 15° at 350° C., more preferably not more than 15° at 350° C. and not more than 25° at 300° C. and/or not more than 50° at 250° C.

By sealing an object to be sealed with it, and then inducing its crystallization, the sealant of the present invention enables a lowered thermal expansion coefficient, an improved mechanical strength, and thermal shock resistance as well. To induce crystallization, the sealant may be kept for a certain length of time at a temperature not lower than its glass transition temperature and not higher than its liquidus temperature. For rapid and secure crystallization, the sealant may be kept for about one minute to one hour at a temperature in the range of 50° C. to 100° C. to cause nucleation, and then for about one minute to one hour at 100° C. to 150° C. to let crystals grow.

In providing a seal with the sealant of the present invention, the working atmosphere may either contain oxygen or be oxygen free. In sealing, it is possible to apply pressure on the object to be sealed to further enhance adhesiveness, and also to expose the sealant to vibration, such as ultrasound, to promote its melting.

The sealant of the present invention can be used in various electronic components, such as quartz resonators, semiconductor elements, SAW elements, and organic EL elements. In addition, it can be used in sealing components for which leakage of low molecular/atomic weight gas, such as hydrogen or helium, would pose a problem, or components in which vacuum must be maintained.

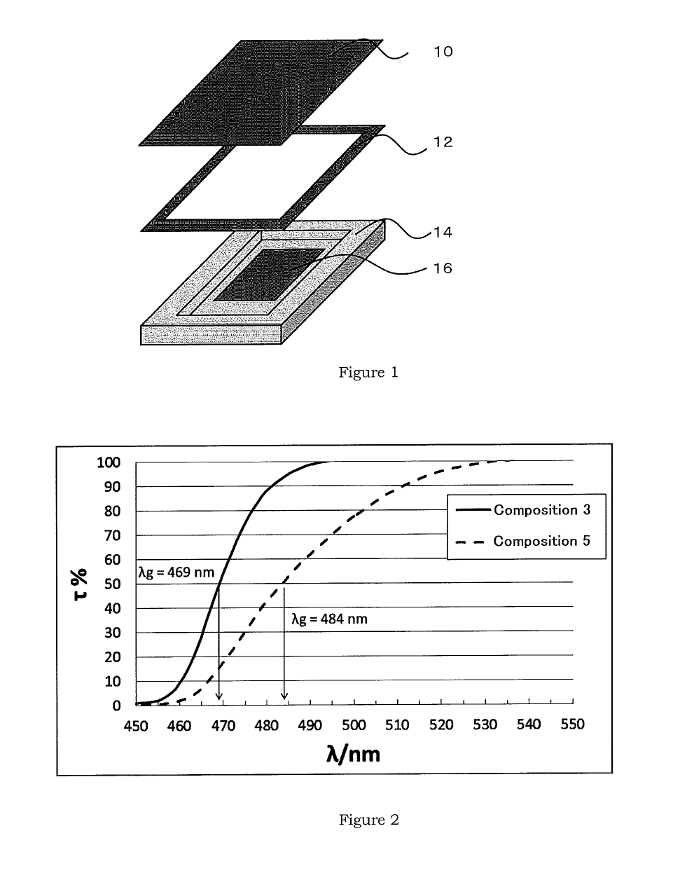

FIG. 1 is a schematic disassembled view of the structure of a quartz resonator in which the sealant 12 of the present invention is used.

### EXAMPLES

Though the present invention is described below in further detail with reference to examples, it is not intended that the present invention be restricted to the examples.

According to the formulation ratios shown in Tables 1-5, raw materials were weighed and blended for each composition so that their total weight is 5 g, and the pulverized and mixed in a mortar to provide a powder. The 5-g powder thus obtained was put in a ceramic crucible. The crucible was placed in a furnace heated at 450° C. in the air and kept there for 10 minutes to melt the mixed raw materials. The melt was poured on a graphite plate and cooled to prepare each bulk composition.

[Evaluation of Physical Properties]

The physical properties of the bulks obtained above were evaluated by the method described below.

1. Evaluation of Absorption Edge

Each bulk of Compositions 1-26, about 100 mg, was placed as a sample on the center of a glass microscope slide, and zirconia beads having a mean particle size of about 50 μm were placed on the areas near both ends of the glass microscope slide. Another glass microscope slide was placed to cover the former. The two superimposed glass microscope slides were placed in a furnace heated at a fixed temperature (300° C. for Compositions 1-13, 16-25; 350° C. for Compositions 14-15, 26). One minute later, they were taken out of the furnace and cooled to room temperature, with a weight placed on them. After cooling, the thickness of the sample was determined using a micrometer. This determination was performed by subtracting the thickness of the two glass microscope slides from the total thickness of the superimposed glass microscope slides with a sandwiched sample between them. The thickness of the samples was within a range of 40-70 μm. On a spectrophotometer (Model “U-3010”, mfd. by Hitachi High-Technologies Corp.) equipped with integrating sphere, total transmittance of the two glass microscope slides and the sample between them was determined at 700 nm and other various wavelengths A, with the incident light angle set at 0 degree, and the absorption edge wavelength was calculated for each of the samples using Numerical Formulae 1-3 aforementioned.

### [Results]

FIG. 2 shows the internal transmittance in Compositions 3 and 5 as transmittance specter curves. And the value of absorption edge wavelength of each composition is shown in Tables 1-5.

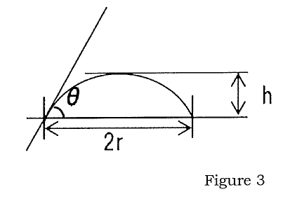

2. Evaluation of Wettability Each bulk of Compositions 1-26 was machined into a sample in a cylindrical form with 3 mm diameter×5 mm height. Each sample was put in the standing position on the top face (the face set on the air side during float glass production) of a glass plate (soda-lime glass), 25 mm square and 1.3 mm thick, and placed in a furnace. After elevating the temperature up to 250° C., 300° C., or 350° C., at a rate of 5° C./min, the respective temperatures were kept for one hour, and heating was terminated to let the sample cool down. The shape of the sample on the glass plate was examined, and the parameters shown in FIG. 3 measured, based on which the contact angle θ was calculated by the θ/2 method.

$$θ = 2 arctan \frac{h}{r} \qquad [ Numerical Formula 4 ]$$

### [Results]

Tables 1-5 show the contact angle of each composition with the glass plate.

TABLE 1

| Composition No. | 1 | 2 | 3 | 4 | 5 | 6 |
|---|---|---|---|---|---|---|
| Example/Comparative | Comparative | Exam- | Comparative | Comparative | Exam- | Comparative |
| example | example | ple | example | example | ple | example |
| Raw materials blend ratio | mol | mol | mol | mol | mol | mol |
| AgI | 70 | 70 | 40 | 40 | 40 | 37 |
| AgBr | | | | | | |
| AgCl | | | | | | |
| Ag₂O | | 0.5 | | | 0.5 | |
| Ag₂MoO₄ | 10 | 10 | 20 | 20 | 20 | 21 |
| MoO₃ | | | | 0.1 | | |
| WO₃ | | | | | | |
| K₂MoO₄ | | | | | | |
| MgO | | | | | | |
| ZnO | | | | | | |
| Ag₃PO₄ | | | | | | |
| Composition | mol % | mol % | mol % | mol % | mol % | mol % |
| AgI | 70.0 | 69.3 | 40.0 | 40.0 | 39.6 | 37.0 |
| AgBr | | | | | | |
| AgCl | | | | | | |
| AgO_{1/2} | 20.0 | 20.8 | 40.0 | 40.0 | 40.6 | 42.0 |
| MoO₃ | 10.0 | 9.9 | 20.0 | 20.1 | 19.8 | 21.0 |
| WO₃ | | | | | | |
| KO_{1/2} | | | | | | |
| MgO | | | | | | |
| ZnO | | | | | | |
| PO_{5/2} | | | | | | |
| Total | 100.0 | 100.0 | 100.0 | 100.0 | 100.0 | 100.0 |
| MoO₃ + WO₃ | 10.0 | 9.9 | 20.0 | 20.1 | 19.8 | 21.0 |
| ΣAgQ_{1/q} | 90.0 | 90.1 | 80.0 | 79.9 | 80.2 | 79.0 |
| ΣMO_{m/2} | 30.0 | 30.7 | 60.0 | 60.0 | 60.4 | 63.0 |
| (2 × MoO₃ + 2 × WO₃ + 3 × PO_{5/2})/ | 1.000 | 0.952 | 1.000 | 1.005 | 0.976 | 1.000 |
| (AgO_{1/2} + R¹O_{1/2}) + 2 × R²O) | | | | | | |
| λ_{g} (nm) | 465 | 510 | 469 | 467 | 484 | 468 |
| Contact angle θ (°) | | | | | | |
| 250° C. kept 1 hr | 63 | 63 | 60 | 68 | 50 | 62 |
| 300° C. kept 1 hr | 44 | 33 | 42 | 49 | 27 | 27 |
| 350° C. kept 1 hr | 25 | 12 | 29 | 41 | 14 | 17 |

TABLE 2

| Composition No. | 7 | 8 | 9 | 10 | 11 | 12 |
|---|---|---|---|---|---|---|
| Example/Comparative | Exam- | Comparative | Exam- | Comparative | Exam- | Comparative |
| example | ple | example | ple | example | ple | example |
| Raw materials blend ratio | mol | mol | mol | mol | mol | mol |
| AgI | 37 | 34 | 34 | 31 | 31 | 28 |
| AgBr | | | | | | |
| AgCl | | | | | | |
| Ag₂O | 0.5 | | 0.5 | | 0.5 | |
| Ag₂MoO₄ | 21 | 22 | 22 | 23 | 23 | 24 |
| MoO₃ | | | | | | |
| WO₃ | | | | | | |
| K₂MoO₄ | | | | | | |
| MgO | | | | | | |
| ZnO | | | | | | |
| Ag₃PO₄ | | | | | | |
| Composition | mol % | mol % | mol % | mol % | mol % | mol % |
| AgI | 36.6 | 34.0 | 33.7 | 31.0 | 30.7 | 28.0 |
| AgBr | | | | | | |
| AgCl | | | | | | |
| AgO_{1/2} | 42.6 | 44.0 | 44.6 | 46.0 | 46.5 | 48.0 |
| MoO₃ | 20.8 | 22.0 | 21.8 | 23.0 | 22.8 | 24.0 |
| WO₃ | | | | | | |
| KO_{1/2} | | | | | | |
| MgO | | | | | | |
| ZnO | | | | | | |
| PO_{5/2} | | | | | | |
| Total | 100.0 | 100.0 | 100.0 | 100.0 | 100.0 | 100.0 |
| MoO₃ + WO₃ | 20.8 | 22.0 | 21.8 | 23.0 | 22.8 | 24.0 |
| ΣAgQ_{1/q} | 79.2 | 78.0 | 78.2 | 77.0 | 77.2 | 76.0 |
| ΣMO_{m/2} | 63.4 | 66.0 | 66.3 | 69.0 | 69.3 | 72.0 |
| (2 × MoO₃ + 2 × WO₃ + 3 × PO_{5/2})/ | 0.977 | 1.000 | 0.978 | 1.000 | 0.979 | 1.000 |
| (AgO_{1/2} + R¹O_{1/2}) + 2 × R²O) | | | | | | |
| λ_{g} (nm) | 490 | 470 | 490 | 471 | 491 | 471 |
| Contact angle θ (°) | | | | | | |
| 250° C. kept 1 hr | 52 | 125 | 113 | Not | Not | Not |
| | | | | soften | soften | soften |
| 300° C. kept 1 hr | 21 | 27 | 24 | 26 | 24 | 31 |
| 350° C. kept 1 hr | 13 | 17 | 14 | 17 | 12 | 17 |

TABLE 3

| Composition No. | 13 | 14 | 15 | 16 | 17 | 18 |
|---|---|---|---|---|---|---|
| Example/Comparative | Exam- | Comparative | Exam- | Exam- | Exam- | Exam- |
| example | ple | example | ple | ple | ple | ple |
| Raw materials blend ratio | mol | mol | mol | mol | mol | mol |
| AgI | 28 | 56 | 56 | 40 | 40 | 40 |
| AgBr | | | | | | |
| AgCl | | | | | | |
| Ag₂O | 0.5 | 14 | 15 | 0.5 | 1.5 | |
| Ag₂MoO₄ | 24 | | | 19 | 19 | 20 |
| MoO₃ | | | | | | |
| WO₃ | | 14 | 14 | | | |
| K₂MoO₄ | | | | 1 | 1 | |
| MgO | | | | | | 2 |
| ZnO | | | | | | |
| Ag₃PO₄ | | | | | | |
| Composition | mol % | mol % | mol % | mol % | mol % | mol % |
| AgI | 27.7 | 57.1 | 56.0 | 39.6 | 38.8 | 39.2 |
| AgBr | | | | | | |
| AgCl | | | | | | |
| AgO_{1/2} | 48.5 | 28.6 | 30.0 | 38.6 | 39.8 | 39.2 |
| MoO₃ | 23.8 | | | 19.8 | 19.4 | 19.6 |
| WO₃ | | 14.3 | 14.0 | | | |
| KO_{1/2} | | | | 2.0 | 1.9 | |
| MgO | | | | | | 2.0 |
| ZnO | | | | | | |
| PO_{5/2} | | | | | | |
| Total | 100.0 | 100.0 | 100.0 | 100.0 | 100.0 | 100.0 |
| MoO₃ + WO₃ | 23.8 | 14.3 | 14.0 | 19.8 | 19.4 | 19.6 |
| ΣAgQ_{1/q} | 76.2 | 85.7 | 86.0 | 78.2 | 78.6 | 78.4 |
| ΣMO_{m/2} | 72.3 | 42.9 | 44.0 | 60.4 | 61.2 | 60.8 |
| (2 × MoO₃ + 2 × WO₃ + 3 × PO_{5/2})/ | 0.980 | 1.000 | 0.933 | 0.976 | 0.930 | 0.909 |
| (AgO_{1/2} + R¹O_{1/2}) + 2 × R²O) | | | | | | |
| λ_{g} (nm) | 490 | 476 | 501 | 487 | 492 | 486 |
| Contact angle θ (°) | | | | | | |
| 250° C. kept 1 hr | Not | Not | Not | 42 | 46 | 40 |
| | soften | soften | soften | | | |
| 300° C. kept 1 hr | 30 | Not | Not | 17 | 21 | 20 |
| | | soften | soften | | | |
| 350° C. kept 1 hr | 14 | 16 | 9 | 12 | 13 | 10 |

TABLE 4

| | Composition No. | | | |
|---|---|---|---|---|
| | 19 | 20 | 21 | 22 |
| | Example/Comparative example | | | |
| | Compar- | | Compar- | |
| | ative | | ative | |
| | example | Example | example | Example |
| Raw materials blend ratio | mol | mol | mol | mol |
| AgI | 39 | 39 | 38 | 38 |
| AgBr | | | 1 | 1 |
| AgCl | | | 1 | 1 |
| Ag₂O | | 0.5 | | 0.5 |
| Ag₂MoO₄ | 19 | 19 | 20 | 20 |
| MoO₃ | | | | |
| WO₃ | | | | |
| K₂MoO₄ | | | | |
| MgO | | | | |
| ZnO | | | | |
| Ag₃PO₄ | 1 | 1 | | |
| Composition | mol % | mol % | mol % | mol % |
| AgI | 39.0 | 38.6 | 38.0 | 37.6 |
| AgBr | | | 1.0 | 1.0 |
| AgCl | | | 1.0 | 1.0 |
| AgO_{1/2} | 41.0 | 41.6 | 40.0 | 40.6 |
| MoO₃ | 19.0 | 18.8 | 20.0 | 19.8 |
| WO₃ | | | | |
| KO_{1/2} | | | | |
| MgO | | | | |
| ZnO | | | | |
| PO_{5/2} | 1.0 | 1.0 | | |
| Total | 100.0 | 100.0 | 100.0 | 100.0 |
| MoO₃ + WO₃ | 19.0 | 18.8 | 20.0 | 19.8 |
| ΣAgQ_{1/q} | 80.0 | 80.2 | 80.0 | 80.2 |
| ΣMO_{m/2} | 61.0 | 61.4 | 60.0 | 60.4 |
| (2 × MoO₃ + 2 × | 1.000 | 0.976 | 1.000 | 0.976 |
| WO₃ + 3 × PO_{5/2})/ | | | | |
| (AgO_{1/2} + R¹O_{1/2}) + | | | | |
| 2 × R²O) | | | | |
| λ_{g} (nm) | 475 | 494 | 471 | 493 |
| Contact angle θ (°) | | | | |
| 250° C. kept 1 hr | 58 | 55 | 55 | 38 |
| 300° C. kept 1 hr | 37 | 25 | 37 | 19 |
| 350° C. kept 1 hr | 18 | 11 | 22 | 11 |

TABLE 5

| | Composition No. | | | |
|---|---|---|---|---|
| | 23 | 24 | 25 | 26 |
| | Example/Comparative example | | | |
| | Compar- | | | |
| | ative | | | |
| | example | Example | Example | Example |
| Raw materials blend ratio | mol | mol | mol | mol |
| AgI | 40 | 40 | 50 | 56 |
| AgBr | | | | |
| AgCl | | | | |
| Ag₂O | | 0.5 | 2.5 | 15 |
| Ag₂MoO₄ | 17 | 17 | 14 | |
| MoO₃ | | | | |
| WO₃ | | | | 14 |
| K₂MoO₄ | | | | |
| MgO | | | | |
| ZnO | 3 | 3 | 3 | 2 |
| Ag₃PO₄ | | | | |
| Composition | mol % | mol % | mol % | mol % |
| AgI | 42.6 | 42.1 | 50.0 | 54.9 |
| AgBr | | | | |
| AgCl | | | | |
| AgO_{1/2} | 36.2 | 36.8 | 33.0 | 29.4 |
| MoO₃ | 18.1 | 17.9 | 14.0 | |
| WO₃ | | | | 13.7 |
| KO_{1/2} | | | | |
| MgO | | | | |
| ZnO | 3.2 | 3.2 | 3.0 | 2.0 |
| PO_{5/2} | | | | |
| Total | 100.0 | 100.0 | 100.0 | 100.0 |
| MoO₃ + WO₃ | 18.1 | 17.9 | 14.0 | 13.7 |
| ΣAgQ_{1/q} | 78.7 | 78.9 | 83.0 | 84.3 |
| ΣMO_{m/2} | 57.4 | 57.9 | 50.0 | 45.1 |
| (2 × MoO₃ + 2 × | 1.000 | 0.971 | 0.848 | 0.933 |
| WO₃ + 3 × PO_{5/2})/ | | | | |
| (AgO_{1/2} + R¹O_{1/2}) + | | | | |
| 2 × R²O) | | | | |
| λ_{g} (nm) | 476 | 494 | 513 | 501 |
| Contact angle θ (°) | | | | |
| 250° C. kept 1 hr | 64 | 41 | 30 | Not |
| | | | | soften |
| 300° C. kept 1 hr | 41 | 18 | 24 | Not |
| | | | | soften |
| 350° C. kept 1 hr | 28 | 12 | 12 | 13 |

As seen in Tables 1-5, any of Compositions 2, 5, 7, 9, 11, 13, 15-18, 20, 22, and 24-26 (i.e., all the examples) has its absorption edge wavelength at 480 nm or longer, and shows a contact angle not larger than 15° with the glass plate at 350° C. These results indicate that compositions set forth as Examples can be properly used to seal inorganic oxides at the temperature. In contrast, any of Compositions 1, 3, 4, 6, 8, 10, 12, 14, 19, 21, and 23 (i.e., all the comparative examples) has its absorption edge wavelength shorter than 480 nm, and shows a contact angle larger than 15° with the glass plate at 350° C., indicating that they are inferior to the examples as sealants for inorganic oxides at the temperature.

Looking to the contact angle data of the compositions in Tables 1-5 with the glass plate at 300° C., it is seen that among the compositions of Examples which soften at this temperature, Compositions 7, 9, 11, 16-18, 20, 22 and 24-25 exhibit contact angle values not larger than 25° with glass plate, indicating that these can be properly used at this temperature, too, to seal inorganic oxides. In contrast, as none of the compositions of Comparative Examples that soften at 300° C. shows a contact angle not larger than 25°, any of them cannot be used properly.

Further, looking to the contact angle of the compositions with the glass plate at 250° C. in Tables 1-5, it is seen that among the compositions of Examples which soften at this temperature, Compositions 5, 16-18, 22, and 24-25 exhibit contact angle values not larger than 50° with the glass plate, indicating that these can be properly used at this temperature, too, to seal inorganic oxides. In contrast, none of the compositions of Comparative Examples which soften at 250° C. shows a contact angle not larger than 50°, and any of them cannot be used properly.

3. Helium Leak Test

[Preparation of Samples Sealed Only with Low-Temperature Composition]

A type TO-5 metal cap (Kovar body with nickel plated surface) having an opening at its top according to the specification of the standard metal package for semiconductors, was submerged at its top in the melt of each of Compositions 2, 5, 7, 9, 11, 13, 16-18, 20, 22, 24-25 heated at 300° C., and the metal cap was placed on a table with its composition-wet top upside A quartz glass plate was placed over the metal cap and in this form, they were put in a furnace set at 300° C. After the furnace was kept at 300° C. for ten minutes, heating of the furnace was terminated, and the metal cap was allowed to cool down within the furnace. It was found that the metal cap and the quartz glass plate were adhered to each other.

[Method for Evaluation of Helium Leak]

In performing a helium leak test, the vacuum spraying method defined in JIS Z 2331:2006 was employed. As a leak detector, HELIOT700 (mfd. by ULVAC, Inc.) was employed.

Helium leak was not detected with any of Compositions 2, 5, 7, 9, 11, 13, 16-18, 20, 22, and 24-25, at a detection sensitivity of 5×10⁻¹¹ Pa*m³/sec. This indicates that the compositions adhered to both surfaces of Kovar (metal) and glass (inorganic oxides) without leaving a gap, and thereby provided an excellent hermetically sealed condition.

### INDUSTRIAL APPLICABILITY

The low melting-point composition according to the present invention is useful, for it can be employed as a sealant for electric/electronic components, such as quarts resonators, LED chips.

### DESCRIPTION OF SIGNS

10 Lid
12 Sealant
14 Ceramic substrate
16 Quartz resonator

1. A low melting-point composition comprising one or two elements chosen from Mo and W, and further Ag, I, and O as essential components,
wherein the composition, as expressed as a mass of different compounds each formed of a cation-anion combination represented by the formula MQ_{m/q}, wherein M denotes a cation having a valence of m, and Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

(2×MoO₃+2×WO₃+3×PO_{5/2})/(AgO_{1/2}+R¹O_{1/2}+2×R²O)<1, wherein R¹ denotes an alkali metal, and R² denotes alkaline earth metal, and
wherein the composition exhibits a small contact angle with an oxide surface.

2. A low melting-point composition comprising one or two elements chosen from Mo and W, and further Ag, I, and O as essential components,
wherein the composition, as expressed as a mass of different compounds each formed of a cation-anion combination represented by the formula MQ_{m/q}, wherein M denotes a cation having a valence of m, and Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

wherein the absorption edge wavelength kg of the composition is 480 nm or longer.

3. The low melting-point composition according to claim 1, comprising one or two elements chosen from Mo and W, and further Ag, I, and O, as exclusive components, and
the composition satisfies (2×MoO₃+2×WO₃)/AgOᵥ₂<1.

4. The low melting-point composition according to claim 1, containing substantially no AgF, AgCl, nor AgBr.

5. A method for production of a low melting-point composition that comprises one or two elements chosen from Mo and W, and further Ag, I, and O, and exhibits a small contact angle with an oxide surface, comprising the steps of:
providing and blending raw materials so that the composition, as expressed as a mass of different compounds each formed of a cation-anion combination represented by the formula MQ_{m/q}, wherein M denotes a cation having a valence of m, Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

(2×MoO₃+2×WO₃+3×PO_{5/2})/(AgO_{1/2}+R¹O_{1/2}+2×R²O)<1, wherein R¹ denotes an alkali metal, and R² denotes alkaline earth metal, and
heating to turn the raw materials into a melt, and
cooling the melt into a solid.

6. A method for production of a low melting-point composition that comprises one or two elements chosen from Mo and W, and further Ag, I, and O, and exhibits a small contact angle with an oxide surface, comprising the steps of:
providing and blending raw materials so that the composition, as expressed as a mass of different compounds each formed of a cation-anion combination represented by the formula MQ_{m/q}, wherein M denotes a cation having a valence of m, Q denotes an anion having a valence of q, and assumed that any anion except the oxide anion (O²⁻) is bound to Ag ion, satisfies the following requirements with regard to the proportion of the compounds in the composition:

| | |
|---|---|
| AgI | 12-82 mole %, |
| AgO_{1/2} | 12-60 mole %, |
| MoO₃ + WO₃ | 6-28 mole %, |
| ΣAgQ_{1/q} | 68-94 mole %, and |
| ΣMO_{m/2} | 18-88 mole %, and further |

the absorption edge wavelength kg of the composition is 480 nm or longer, and
heating to turn the raw materials into a melt, and
cooling the melt into a solid.

7. The method for production according to claim 5,
comprising the steps of:
providing and blending raw materials so that the low melting-point composition comprises one or two elements chosen from Mo and W, and further Ag, I, and O, as exclusive components, and further
(2×MoO₃+2×WO₃)/AgO_{1/2}<1, and
heating to turn the raw materials into a melt, and
cooling the melt into a solid.

8. The method for production according to claim 5, comprising the steps of providing and blending raw materials so that the low melting-point composition contains substantially no AgF, AgCl, nor AgBr, heating to turn the raw materials into a melt, and cooling the melt into a solid.

9. A low melting-point sealant comprising the low melting-point composition according to claim 1.

10. An electronic component produced using the sealant according to claim 9.

11. An electronic component comprising two or more members joined with the low melting-point sealant according to claim 9.

12. The electronic component according to claim 10 as a quartz resonator, a semiconductor element, an SAW element, or an organic EL element.
